(19) United States
(12) Patent Application Publication
(10) Pub. No.: US 2023/0191841 A1
(43) Pub. Date: Jun. 22, 2023

(54) LIGHT TRUCK OR OFF-ROAD TIRE

(71) Applicant: The Goodyear Tire & Rubber Company, Akron, OH (US)

(72) Inventors: Douglas Andrew Till, Akron, OH (US); James Gregory Gillick, Akron, OH (US); Ceyhan Celik, Stow, OH (US)

(21) Appl. No.: 17/552,575

(22) Filed: Dec. 16, 2021

(51) Int. Cl. B60C 9/18; B60C 9/00; B60C 9/08

(52) U.S. Cl. CPC B60C 9/1821; B60C 9/005; B60C 9/08; B60C 2009/2096

(57) ABSTRACT

A tire includes a tread, a crown reinforcement, a carcass reinforcement with at least one ply wound about a pair of bead cores and through two sidewalls of the tire, and a cut/puncture resistant sidewall layer disposed adjacent a part of the carcass reinforcement within one of the sidewalls, the cut/puncture sidewall layer being formed of a plurality of cords, each cord including one nylon cord having S 4-8 tpi (twists per inch), one aramid cord having Z 4-8 tpi, and the nylon cord and the aramid cord being twisted together with S 3-7 tpi.

### FIELD OF THE INVENTION

The present invention relates to a light truck or off-road tire. More particularly, a tire structure for enhancing cut and/or puncture resistance of the tire.

### BACKGROUND OF THE INVENTION

With the continuing rise in popularity of light trucks and off-road vehicles, there exists a need to provide tires that have the ability to be driven on paved roads while carrying heavy loads without excessive noise yet also to be capable of being driven in heavy snow or wet roads. Often these tires will be driven in flooded and/or wet roadway conditions. Historically, tires have been able to meet one or two of the above-referenced design requirements but usually at the sacrifice of the other design features, such as cut/puncture resistance. It would be advantageous for a tire structure to reasonably resist cuts and/or punctures.

### SUMMARY OF THE INVENTION

A tire in accordance with the present invention includes a tread, a crown reinforcement, a carcass reinforcement with at least one ply wound about a pair of bead cores and through two sidewalls of the tire, and a cut/puncture resistant sidewall layer disposed adjacent a part of the carcass reinforcement within one of the sidewalls, the cut/puncture sidewall layer being formed of a plurality of cords, each cord including one nylon cord having S 4-8 tpi (twists per inch), one aramid cord having Z 4-8 tpi, and the nylon cord and the aramid cord being twisted together with S 3-7 tpi.

According to another aspect of the tire, the nylon cord has a S 5-7 tpi.

According to still another aspect of the tire, the aramid cord has a Z 5-7 tpi.

According to yet another aspect of the tire, the nylon cord and aramid cord are twisted together with S 4-6 tpi.

According to still another aspect of the tire, the nylon cord has about a S 6 tpi.

According to yet another aspect of the tire, the aramid cord has about a Z 6 tpi.

According to still another aspect of the tire, the nylon cord and aramid cord are twisted together with about a S 5 tpi.

According to yet another aspect of the tire, the twist of the nylon cord and the twist of the aramid cord are equal.

### BRIEF DESCRIPTION OF THE DRAWINGS

A full and enabling disclosure of the present invention, including the best mode thereof, directed to one of ordinary skill in the art, is set forth more particularly in the remainder of the specification, which references the appended Figures, in which:

FIG. 1 is a schematic cross-sectional view of the tire in accordance with the present invention.

FIG. 2 is a schematic perspective view of an example tread for use with the tire of FIG. 1.

FIG. 3 is a schematic plan view of the example tread of FIG. 2.

FIG. 4 is a schematic enlarged fragmentary view of the example tread of FIG. 2.

### DEFINITIONS

As used herein and in the claims:

“Apex” means an elastomeric filler located radially above the bead core and between the plies and the turnup ply.

“Annular” means formed like a ring.

“Aramid” and “Aromatic polyamide” both mean a manufactured fiber in which the fiber-forming substance is generally recognized as a long chain of synthetic aromatic polyamide in which at least 85 percent of the amide linkages are attached directly to the two aromatic rings. Representative of an aramid or aromatic polyamide is a poly (p-phenyleneterephthalamide).

“Aspect ratio” means the ratio of a tire section height to its section width. For example, the aspect ratio may be the maximum axial distance between the exterior of the tire sidewalls when unloaded and inflated at normal pressure, multiplied by 100% for expression as a percentage. Low aspect ratio may mean a tire having an aspect ratio of 65 and below.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Cord twist” means each yarn of the cord has its component filaments twisted together a given number of turns per unit of length of the yarn (usually expressed in turns per inch (TPI) or turns per meter (TPM)) and additionally the yarns are twisted together a given number of turns per unit of length of the cord. The direction of twist refers to the direction of slope of the spirals of a yarn or cord when it is held vertically. If the slope of the spirals conforms in direction to the slope of the letter “S”, then the twist is called “S” or “left hand”. If the slope of the spirals conforms in direction to the slope of the letter “Z”, then the twist is called “Z” or “right hand”. An “S” or “left hand” twist direction is understood to be an opposite direction from a “Z” or “right hand” twist. “Yarn twist” is understood to mean the twist imparted to a yarn before the yarn is incorporated into a cord, and “cord twist” is understood to mean the twist imparted to two or more yarns when they are twisted together with one another to form a cord. “dtex” is understood to mean the weight in grams of 10,000 meters of a yarn before the yarn has a twist imparted thereto.

“Cut belt ply” refers to a belt having a width less than the tread width, which lies flat over the carcass plies in the crown area of the tire.

“Crown” means that portion of the tire in the proximity of the tire tread.

“Denier” means the weight in grams per 9000 meters (unit for expressing linear density).

“Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Evolving tread pattern” means a tread pattern, the running surface of which, which is intended to be in contact with the road, evolves with the wear of the tread resulting from the travel of the tire against a road surface, the evolution being predetermined at the time of designing the tire, so as to obtain adhesion and road handling performances which remain substantially unchanged during the entire period of use/wear of the tire, no matter the degree of wear of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc. “Mega tensile steel (MT)” means a carbon steel with a tensile strength of at least 4500 MPa at 0.20 mm filament diameter.

“Monofilament” means a single, generally large filament of synthetic fiber

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” means stress expressed as force per unit linear density of the unstrained specimen (cN/tex).

“Tensile stress” is force expressed in force/cross-sectional area. Strength in psi=12,800 times specific gravity times tenacity in grams per denier.

“Tension” for a cord means force on the cord expressed as mN/tex.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turns per inch”, or TPI, means turns of cord twist for each inch length of cord.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Warp” means, in weaving/forming of fabric, lengthwise or longitudinal warp yarns, filaments, threads, cables, fibers, and/or cords may be held stationary in tension on a frame or loom while transverse “weft” yarns, filaments, threads, cables, fibers, and/or cords may be drawn through, and inserted over-and-under, the warp yarns, filaments, threads, fibers, and/or cords.

“Weft” means, in weaving/forming of fabric, transverse yarns, filaments, threads, cables, fibers, and/or cords may be drawn through, and inserted over-and-under, “warp” yarns, filaments, threads, cables, fibers, and/or cords. A single weft yarn, filament, thread, cable, fiber, and/or cord of a weft crossing the “warp” yarns, filaments, threads, cables, and/or cords may be termed a “pick”. Conventional weft yarns, filaments, threads, cables, fibers, and/or cords may only function to maintain the lateral spacing of the “warp” yarns, filaments, threads, cables, fibers, and/or cords during assembly and pre-installation handling.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### DETAILED DESCRIPTION OF EXAMPLES OF THE PRESENT INVENTION

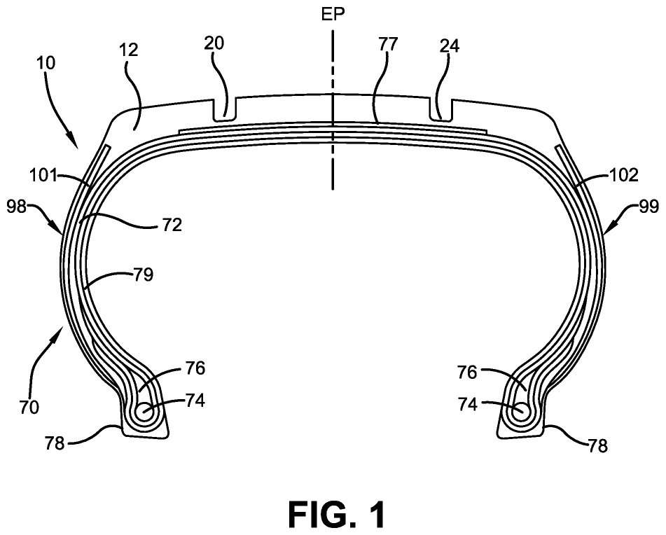

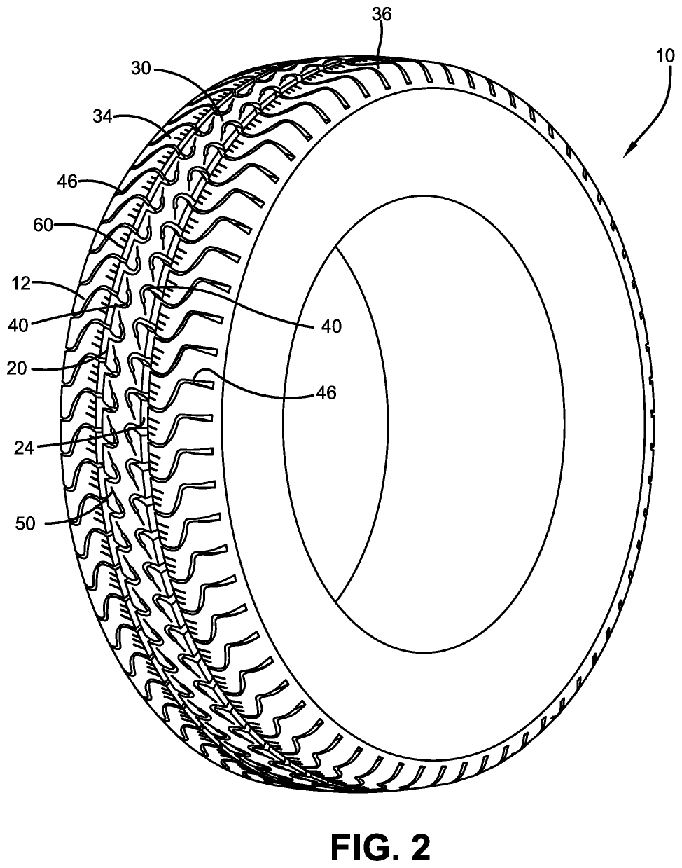

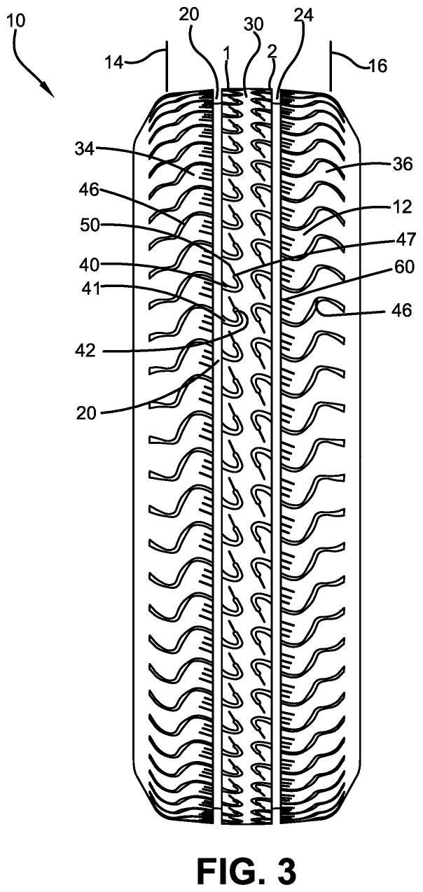

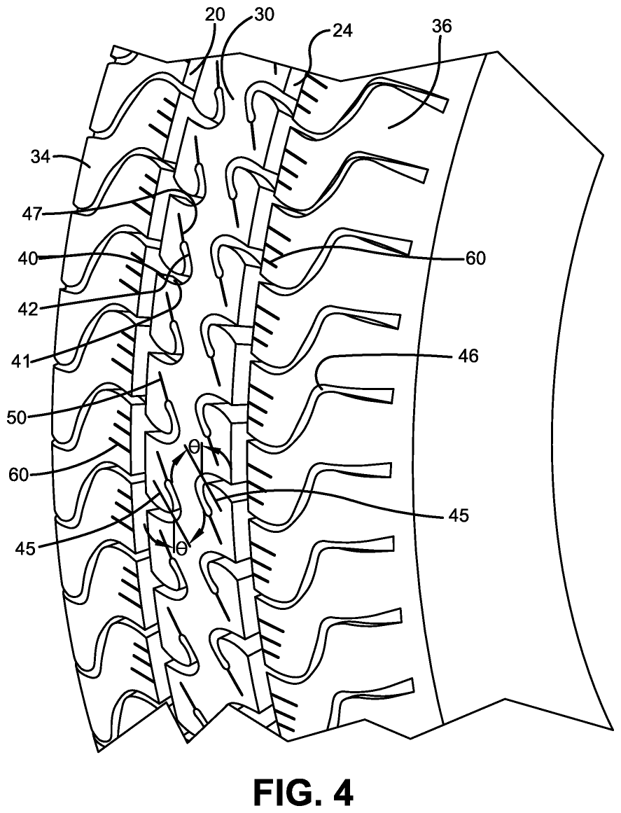

With the reference to FIGS. 1 through 4, a tire (10) in accordance with the present invention is shown. An example tread (12), when configured annularly, may have an axis of rotation and first and second lateral edges (14, 16). The tire of FIG. 4 may include a carcass (70) with one or more plies (72) reinforced by radially extending synthetic or metal cords and a pair of substantially inextensible bead cores (74), an apex (76) radially outward from the bead cores (74) and a belt structure (77) radially outward from the plies (72). The tire (10) may further have an air impervious halobutyl liner (79) and a rubber chafer (78) common in tubeless type tires.

The example tread (12) may have two circumferentially continuous grooves (20, 24). Interposed between the two circumferentially continuous grooves may be a rib (30) extending continuously around the circumference of the tread (12). The rib (30) may have a plurality of circumferentially spaced hook-shaped semi-blind grooves (40) arranged in a first row (1) and a second row (2). The hook-shaped semi-blind grooves (40) of the first row (1) may originate at the circumferentially continuous groove (20) and the hook-shaped semi-blind grooves (40) of the second row (2) may originate from the circumferentially continuous groove (24). Each hook-shaped semi-blind groove (40) may extend obliquely into the rib (30), having a first open portion (41) intersecting the circumferential grooves (20 or 24) and a blind portion (42) extending from the open portion (41). A centerline (45) bisecting the two portions (41,42) as used herein may define the inclination of the hook-shaped semi-blind grooves (40).

The centerline (45) of the hook-shaped semi-blind grooves (40) may be inclined at an angle tin the range between 30 degrees and 60 degrees relative to the equatorial plane (EP) of the tire (10). The equatorial plane (EP) may lie midway between a pair of lateral tread edges and perpendicular to the axis of rotation of the tire (10). The blind portion (42) may extend to an end (47) at which point a sipe incision (50) extends further. The sipe incision (50) may have no width and accordingly be closed when in the contact patch. The hook-shaped semi-blind grooves (40) may have a width in the range between 2 mm and 9 mm. The width of the hook-shaped semi-blind grooves (40) may diminish continuously from the groove portion adjacent the circumferentially extending grooves (20, 22, 24) toward the interior of the rib (30) and may vary between 5.0 mm and 7.5 mm at the intersection of the circumferentially continuous groove and the width at the end portion of the semi-blind grooves may vary between 2.0 mm and 2.5 mm.

The orientation of the hook-shaped semi-blind grooves (40) may allow direct fluids laterally inwardly and expel the fluid as the tire (10) rotates in the generally circumferential direction. Similarly, noise generated by the tread (10) at the rib (30) may at least partially direct itself laterally inwardly and be is expelled as the tire (10) rotates circumferentially from the blind portion (42).

The shoulders of the tread (12) adjacent each lateral tread edge (14,16) may have a rib (34, 36). The ribs (34, 36) may each have a plurality of circumferentially spaced curved grooves (46). Each curved groove (46) may originate at a circumferentially continuous groove (20, 24) and at its origin the curved groove (46) may be linearly aligned with a hook-shaped semi-blind groove (40) such that the originating open portion (41) is inclined similarly to the originating portion of the curved groove (46). The curved groove (46) may bend about 90 degrees relative to its origin and then open laterally over the tread shoulders. In each bend of the curved groove (46) may be a tie bar.

Yarn and cord twisting may be done using any appropriate equipment. A balanced twist, that is, where the ply (yarn) twist is essentially equal to the cable (cord) twist, has been conventionally used. However, an unbalanced cord twist may be used as the physical properties and fatigue life are typically dominated by the cable twist, not the yarn ply twist. An exemplary yarn denier of about 500 to about 6000 may be used. The denier per filament may be about 2 dpf (denier per foot), or between about 5 dpf and about 10 dpf.

When cords have unbalanced S and Z twists used alternately in the cord fabric, the torques formed in dipped and calendered cord fabric in S and Z directions may offset/neutralize each other and eliminate processing challenges. The Z and S twisted alternate cords may also be utilized in steel cord plies. Conventionally, no more than five (5) unbalanced twist S cords or five (5) unbalanced twist Z cords may be adjacent to each other in a fabric, unless other measures are used to neutralize the torque imbalances of the cords in the fabric. Otherwise, roll up issues may be encountered.

For example, some conventional plies have included cords with reduced yarn twist while maintaining the conventional cord twist. When a Z ply twist of 197 tpm (turns per meter) (5 tpi (turns per inch)) is used, an S cord twist of 334 tpm to 472 tpm (8.5 to 12 tpi) may be used. In another example, yarn twists of 118 tpm to 472 tpm (3 to 12 tpi) may be used as long as the twist multiplier (TM) is 10 or less and the yarn twist is maintained less than the cord twist. It has been found, however, that treated fabric and reinforced rubber composites made with such cords may be difficult to process since the residual torque, caused by the unbalanced twist in the cords, causes the treated fabric, and sometimes the fabric reinforced composite, to roll up at the edges.

As shown in FIG. 4, the tire (10) in accordance with the present invention may further include a reinforcement structure (101, 102) disposed in each sidewall (98, 99) of the tire (10). The reinforcement structures (101, 102) may each define a compliant aramid/nylon hybrid fabric layer enabling sidewall impact energy to dissipate through the reinforcement structures (101, 102). By dissipating more energy through compliance, each sidewall (98, 99) may avoid tearing damage for projectiles to the tire (10). Hybrid cord constructions of a compliant aramid/nylon hybrid fabric (101, 102) may have unbalanced cord twists which accentuate the extensibility of the nylon in the hybrid during low strains of the load elongation curves of the constructions (101, 102), as similarly shown in U.S. Pat. Nos. 9,688,100 and 6,959,534, incorporated herein by reference in their entirety.

During deformation of the tire sidewalls (98, 99), low loads at low elongation may allow the reinforcement structures (101, 102) to elongate and envelop potentially damaging projectiles. With high strain, cutting types of damage, the higher aramid modulus and higher break strength may allow the sidewalls (98, 99) to avoid damage incurred by conventional structures.

Thus, in accordance with the present invention, aramid and nylon cords may have a lower twist for promoting this enveloping puncture resistance while the overall hybrid cord may have a higher twist for promoting cut resistance. One example cord may include one nylon cord having S 4-8 tpi (twists per inch), one aramid cord having Z 4-8 tpi, and the two cords twisted together with S 3-7 tpi. The example cord, with the unbalanced twist, may thereby exhibit a load elongation curve with extensibility similar to nylon in the low elongation part of the curve and high modulus and cut resistance of similar to aramid in the high elongation part of the curve. The cord may thus exhibit both compliance and cut resistance.

Variations in the present invention are possible in light of the description of it provided herein. While certain representative examples and details have been shown for the purpose of illustrating the present invention, it will be apparent to those skilled in this art that various changes and/or modifications may be made therein without departing from the scope of the present invention. It is, therefore, to be understood that changes may be made in the particular examples described herein, which will be within the full scope of the present invention as defined by the following appended claims. Further, the present invention is not limited to the examples hereinbefore described, which may be varied in construction and/or detail within the full scope of the appended claims.

What is claimed:

1. A tire comprising:
a tread;
a crown reinforcement;
a carcass reinforcement with at least one ply wound about a pair of bead cores and through two sidewalls of the tire; and
a cut/puncture resistant sidewall layer disposed adjacent a part of the carcass reinforcement within one of the sidewalls, the cut/puncture sidewall layer being formed of a plurality of cords, each cord including one nylon cord having S 4-8 tpi (twists per inch), one aramid cord having Z 4-8 tpi, and the nylon cord and the aramid cord being twisted together with S 3-7 tpi.

2. The tire as set forth in claim 1 wherein the nylon cord has a S 5-7 tpi.

3. The tire as set forth in claim 1 wherein the aramid cord has a Z 5-7 tpi.

4. The tire as set forth in claim 1 wherein the nylon cord and aramid cord are twisted together with S 4-6 tpi.

5. The tire as set forth in claim 1 wherein the nylon cord has about a S 6 tpi.

6. The tire as set forth in claim 5 wherein the aramid cord has about a Z 6 tpi.

7. The tire as set forth in claim 6 wherein the nylon cord and aramid cord are twisted together with about a S 5 tpi.

8. The tire as set forth in claim 1 wherein the twist of the nylon cord and the twist of the aramid cord are equal.
